(19) United States
(12) Patent Application Publication
(10) Pub. No.: US 2004/0214736 A1
(43) Pub. Date: Oct. 28, 2004

(54) Hydrophobically modified polysaccharides in household preparations

(76) Inventor: Jashawant J. Modi, New Castle, DE (US)

Correspondence Address: Hercules Incorporated, Hercules Plaza, 1313 N. Market Street, Wilmington, DE, 19894-0001, US

(21) Appl. No.: 10/846,664

(22) Filed: May 17, 2004

Related U.S. Application Data
(62) Division of application No. 08/992,150, filed on Dec. 17, 1997.

(51) Int. Cl. C11D 1/00

(52) U.S. Cl. 510/238

(57) ABSTRACT

A household preparation product composition is composed of from about 0.1% to about 99% by weight of a vehicle system which comprises a hydrophobically modified water soluble polysaccharide polymer which comprises a water soluble polysaccharide polymer backbone, a hydrophobic moiety of 3-alkoxy-2-hydroxypropyl group wherein the alkyl moiety is a straight or branch chain having 3-24 carbon atoms, wherein the hydrophobic moiety is present in an amount up to the amount which renders said polysaccharide less than 1% by weight soluble in water, and at least one other household care ingredient. The composition can be used in a wide range of cleaning, polishing, sanitizing, pesticidal and toilet preparation applications such as air deodorants/fresheners, rug and upholstery shampoos, insect repellent lotions, children's bubble-making solutions, pet care products such as shampoos and deodorizer, soap bar and institutional liquid soap, all purpose kitchen cleaner and disinfectants, toilet bowl cleaners, fabric softener-detergent, fabric softener, fabric sizing agents, dishwashing detergents, vehicle cleaners and shampoos.

This invention relates to the use of hydrophobically modified polysaccharides in household care products (which are define as a cleaning, polishing, sanitizing, pesticidal, and toilet preparations). More specifically, this invention relates to the use of such polysaccharides in such products where the alkyl moiety of the hydrophobe has 3-24 carbon atoms.

### BACKGROUND OF THE INVENTION

Prior to the present invention, water soluble polysaccharides have been used in cleaning, sanitizing, polishing, toilet preparations, and pesticide preparations; applications such as air deodorants/fresheners, rug and upholstery shampoos, insect repellent lotions, all purpose kitchen cleaner and disinfectants, toilet bowl cleaners, fabric softener-detergent combinations, fabric softeners, fabric sizing agents, dishwashing detergents, vehicle cleaners and shampoos. Widely used commercially available polysaccharides include water soluble polysaccharide ethers such as methyl cellulose (MC), hydroxypropylmethylcellulose (HPMC), hydroxyethylcellulose (HEC), hydroxypropylcellulose (HPC), ethylhydroxyethylcellulose (EHEC), hydroxypropyl (HP) guar, hydroxyethyl guar, guar, starch, and other nonionic starch and guar derivatives. The use of these prior art polysaccharides in such products are sometimes associated with processing difficulties such as compatibility with other ingredients, solubility with certain other ingredients, solution clarity (when needed) and stability under alkaline (or acidic) conditions of the products.

U.S. Pat. Nos. 5,106,609, 5,104,646, and 5,100,658 are examples of patents that disclose the use of hydrophobically modified cellulose ethers in cosmetic products. These patents disclose the use of high molecular weight (i.e., 300,000 to 700,000) and long chain alkyl carbon substitution in the hydrophobe (i.e., 8 to 24 carbons ) for use in cosmetic composition. Also, U.S. Pat. Nos. 4,228,277 and 4,352,916 describe hydrophobically modified cellulose ether derivatives, modified with long chain alkyl group substitution in the hydrophobe. U.S. Pat. No. 4,845,207 discloses a hydrophobically modified nonionic, water-soluble cellulose ether and US Patent 4,939,192 discloses the use of such ether in building compositions.

Certain of the prior art cellulose ethers have poor compatibility with salts or poor solubility in certain solvents such as polyhydric alcohols used in cleaning, sanitizing, polishing, pesticide and toilet preparation applications while others are not tolerant of alkaline or acidic conditions. Hence, a need still exists in the industry to have cellulose ethers that have good compatibility with salts, good solubility in certain solvents, and tolerance to acidic or alkaline conditions while producing products that do not have color problems, when desired.

### SUMMARY OF THE INVENTION

The present invention is directed to a household product (which is defined as a cleaning, sanitizing, polishing, pesticide or toilet preparation) composition comprising:

(a) from about 0.1% to about 99% by weight of a vehicle system which comprises a hydrophobically modified water soluble polysaccharide polymer which comprises a water soluble polysaccharide polymer backbone, a hydrophobic moiety selected from the group consisting of: 1) 3-alkoxy-2-hydroxypropyl group wherein the alkyl moiety is a straight or branch chain having 3-24 carbon atoms, or 2) C₃-C₂₄ alkyl, aryl alkyl, alkyl aryl groups and mixtures thereof, wherein the hydrophobic moiety is present in an amount up to the amount which renders said polysaccharide less than 1% by weight soluble in water, and

(b) at least one other cleaning, sanitizing, polishing, pesticide or toilet preparation product ingredient.

### DETAILED DESCRIPTION OF THE INVENTION

It has been surprisingly found that hydrophobically modified polysaccharides have various advantageous properties over prior art water soluble polysaccharides in cleaning, polishing, sanitizing, pesticidal, toilet or perfume products. Any water soluble polysaccharide or derivatives can be used as the backbone to form the hydrophobically modified polysaccharide of this invention. Thus, e.g., hydroxyethylcellulose (HEC), hydroxypropylcellulose (HPC), methylcellulose (MC), hydroxypropylmethylcellulose (HPMC), ethylhydroxyethylcellulose (EHEC), and methylhydroxyethylcellulose (MHEC) and, agar, dextran, locust bean gum, starch, guar and their nonionic derivatives can all be modified. The amount of nonionic substituent such as methyl, hydroxyethyl, or hydroxypropyl does not appear to be critical so long as there is a sufficient amount to assure that the ether is water soluble. The polysaccharides of this invention have a sufficient degree of nonionic substitution to cause them to be water soluble and a hydrophobic moiety where selected from the group consisting of 1) 3-alkoxy-2-hydroxypropyl group wherein the alkyl moiety is a straight or branch chain having 3-24 carbon atoms, or 2) C₃-C₂₄ alkyl, aryl alkyl, alkyl aryl groups and mixtures thereof, wherein the hydrophobic moiety is present in an amount up to the amount which renders said polysaccharide less than 1% by weight soluble in water. When the hydrophobe is an alkyl, aryl alkyl, or alkyl aryl moiety, the number of carbons can be 3-24, preferably 3-22, more preferably 4-18, and most preferably 4-16.

The preferred polysaccharide backbone is hydroxyethylcellulose (HEC). The HEC which is modified to function in this invention is a commercially available material. Suitable commercially available materials are marketed by the Aqualon Company, a division of Hercules Incorporated, Wilmington, Del. U.S.A., under the trademark Natrosol®.

The alkyl modifier, cationic group, anionic group and zwitterionic group can be attached to the polysaccharide backbone via an ether, ester, or urethane linkage. Ether is the preferred linkage as the reagents most commonly used to effect etherification because it is readily obtainable; the reaction is similar to that commonly used for the initial etherification, and the reagents used in the reaction are usually more easily handled than the reagents used for modification via the other linkages. The resulting linkage is also usually more resistant to further reactions.

An example of the polysaccharide of the present invention is the 3-alkoxy-2-hydroxypropylhydroxyethylcellulose that is substantially completely soluble in water at ambient temperature.

The hydrophobic moiety is generally contained in an amount of about 0.05 to about 50 wt. %, preferably about 0.1 to about 25 wt. %, based on the dry weight of the substituted polymer. The alkyl group of the 3-alkoxy-2-hydroxypropyl group can be a straight chain alkyl group or branched alkyl group having 3 to 24 carbon atoms. Exemplary modifying radicals are propyl-, butyl-, pentyl-, 2-ethylhexyl, octyl, cetyl, octadecyl, and docosapolyenoic glycidyl ether.

The hydrophobically modified polysaccharide of the present invention is an essential ingredient of the system. Another ingredient that may be in the system is a surfactant that can be either soluble or insoluble in the composition. A compatible solvent may also be used in the system that can be either a single solvent or a blend of solvents.

Examples of the surfactants are anionic, nonionic, cationic, zwitterionic, or amphoteric type of surfactants. The surfactant can be soluble or insoluble in the present invention and (when used) is present in the composition of from 0.01 to about 50% by weight of the composition. Synthetic anionic surfactants include alkyl and alkyl ether sulfates.

Specific examples of alkyl ether sulfates which can be used in the present invention are sodium coconut alkyl trimethylene glycol ether sulfate; sodium tallow alkyl trimethylene glycol ether sulfate; and sodium tallow alkyl hexaoxyethylene sulfate. Sodium tallow alkyl diethylene glycol ether sulfate; and sodium tallow alkyl sulfate.

Nonionic surfactants, can be broadly defined as compounds containing a hydrophobic moiety and a nonionic hydrophilic moiety. Examples of the hydrophobic moiety can be alkyl, alkyl aromatic, dialkyl siloxane, polyoxyalkylene, and fluoro-substituted alkyls. Examples of hydrophilic moieties are polyoxyalkylenes, phosphine oxides, sulfoxides, amine oxides, and amides.

Cationic surfactants useful in vehicle systems of the compositions of the present invention, contain amino or quaternary ammonium hydrophilic moieties which are positively charged when dissolved in the aqueous composition of the present invention.

Zwitterionic surfactants are exemplified by those which can be broadly described as derivative of aliphatic quaternary ammonium, phosphonium, and sulfonium compounds, which can be broadly described as derivative of aliphatic quaternary ammonium, phosphonium, and sulfonium compounds, in which the aliphatic radicals can be straight or branched chain, and wherein one of the aliphatic substituents contains from about 8 to about 18 carbon atoms and one contains as anionic water-solubilizing group, e.g., carboxy, sulfonate, sulfate, phosphate, or phosphonate.

Examples of amphoteric surfactants which can be used in the vehicle systems of the compositions of the present invention are those which are broadly described as derivatives of aliphatic secondary and tertiary amines in which the aliphatic radical can be straight or branched chain and wherein one of the aliphatic substituents contains from about 8 to about 18 carbon atoms and one contains an anionic water solubilizing group, e.g., carboxy, sulfonate, sulfate, phosphate, or phosphonate.

According to the present invention, the solvent used in the system should be compatible with the other components in the present composition. Examples of the solvents used in the present invention are water, water-lower alkanols mixtures, and polyhydric alcohols having from 3 to 6 carbon atoms and from 2 to 6 hydroxyl groups. Preferred solvents are water, propylene glycol, water-glycerine, sorbitol-water, and water-ethanol. The solvent (when used) in the present invention is present in the composition at a level of from 0.1% to 99% by weight of the composition.

The active component is optional because the dissolved polymer can be the active ingredient component. An example of this is the use of the polymer in a fabric sizing spray. However, when an active ingredient is needed, it must provide some benefit to the user. Examples of substances that may suitably be included according to the present invention are as follows:

1) Perfumes, which give rise to an olfactory response in the form of a fragrance and deodorant perfumes which in addition to providing a fragrance response can also reduce odor;

2) Insect repellent agent whose function is to keep insects from a particular area or attacking skin;

3) Bubble generating agent, such as surfactants which generates foam or lather;

4) Pet deodorizer such as pyrethrins which reduces pet odor;

5) Pet shampoo actives, whose function is to remove dirt, foreign material and germs from the skin and hair surfaces;

6) Industrial grade bar and liquid soap actives that remove germs, dirt, grease and oil from skin and sensitizes skin;

7) All purpose cleaning agents, that remove dirt, oil, grease, germs from the surface in area such as kitchens, bathroom, public facilities

8) Disinfecting ingredients that kill or prevent growth of germs in a house or public facility;

9) Rug and Upholstery cleaning actives which lift and remove dirt and foreign particles from the surfaces and also deliver softening and perfumes;

10) Laundry softener actives which reduces static and makes fabric feel softer;

11) Laundry detergent ingredients which remove dirt, oil, grease, stains and kills germs;

12) Dishwashing detergent actives which removes stains, food, germs;

13) Toilet bowl cleaning agents which removes stains, kills germs, and deodorizes;

14) Laundry prespotter actives which helps in removing stains from clothes;

15) Fabric sizing agent which enhances appearance of the fabric;

16) Vehicle cleaning actives which removes dirt, grease, etc. from vehicles and equipments.

17) Lubricating agent which reduces friction between parts.

The above list is only examples and is not a complete list of active ingredients that can be used. Other ingredients that are use in these types of products are well known in the industry. In addition to the above ingredients conventionally used, the composition according to the present invention can optionally also include ingredients such as a colorant, preservative, antioxidant, activity enhancer, emulsifiers, viscositying agents (such as salts, i.e., NaCl, NH₄Cl & KCl), alcohol and fats and oils.

The vehicle systems and compositions of the present invention can be made using conventional formulation and mixing techniques. Methods of making various types of compositions are described more specifically in the following examples. The following examples are merely set forth for illustrative purpose, 25 but it to be understood that other modifications of the present invention within the skill of artisans in the industry can be made without departing from the spirit and scope of the invention.

Toilet Soap Formula

| Ingredients | Weight % |
|---|---|
| A. Water | 65.70 |
| B. Sodium C14-C16 olefin sulfonate | 20.00 |
| C. Sodium lauroyl sarcosinate | 10.00 |
| D. Cocamide monoethanol amine | 3.00 |
| E. Natrosol-Plus ®* 330 | 0.75 |
| F. Natrosol 250HR** | 0.25 |
| G. Disodium EDTA (Disodium ethylene diamine tetra acetate) | 0.20 |
| H. Methylparaben | 0.10 |
| | 100.00 |

*This polymer is hydrophobically modified hydroxyethylcellulose that is nonionic and contains both hydroxyethyl and long chain (i.e., C₁₆) alkyl group; and has Brookfield viscosity of 150-750 cps at 1% at 25° C.
**This product is hydroxyethylcellulose that is nonionic and has a Brookfield viscosity of 1500-2500 at 1% at 25° C.

### Procedure

1. The Natrosol-Plus and Natrosol 250HR products were dispersed in water and the pH was raised to about 8.0-8.5 while stirring for 45 minutes to dissolve the polymer mixture to form a solution. Methylparaben was then added to this solution.

2. In a separate vessel, the surfactants (components B, C, & D) were combined, heated to 80° C., and mixed until homogeneous.

3. The surfactant solution was then added to the water-soluble polymer solution and mixed until well blended.

4. The Disodium EDTA was added to the blended solution and mixed for about 15 minutes, and then cooled to room temperature.

| Generic or | | |
|---|---|---|
| CTFA Adopted Name | Trademark | Supplier |
| Sodium C14-C16 | Bio-Terge AS-40 | Stepan Chemical Company |
| olefin sulfonate | | Northfield, Illinois |
| Sodium lauroyl | Hamposyl L-30 | W. R. Grace & |
| sarcosinate | | Company |
| | | Nashua, New |
| | | Hampshire |
| Cocamide MEA | Monamid CMA | Mona Industries Inc. |
| | | Paterson, New Jersey |
| | Natrosol 25HR | Hercules Incorporated |
| | | Wilmington, Delaware |
| | Natrosol-Plus 330 | Hercules Incorporated |
| | | Wilmington, Delaware |

Air Freshener Formulations - Hot Process

| | Ingredients | Weight % |
|---|---|---|
| A | Carrageenan (CHP1** from Hercules Incorporated) | 02.00% |
| B | Locust bean Gum | 00.25% |
| C | HMHEC 1* (Hercules Incorporated) | 00.75% |
| D | Water | 93.00% |
| E | Propylene glycol (humectant, solubilizer) | 02.00% |
| F | Total | 01.00% |
| G | | 01.00% |
| | | 100.00% |

*This compound HMHEC 1 is 3-butoxy-2- hydroxypropylhydroxyethylcellulose that has an aqueous viscosity at 25° C. of a minimum of 2500 cps at 1%, measured on a Brookfield LVTD Viscometer, and a cloud point of about 72°-78° C., that is treated with glyoxal.
**CHP1: Kappa carrageenan, not standardized with sugar or salt.
***Germaben II: Preservative, Diazolidinyl urea.
****Fragrance: Cinnamon, Flavor and Fragrance Specialties - Franklin Lake, NJ.

### Procedure

Water was heated to about 90° C. while being stirred and polymers A, B, and C were added to the vortex of water and mixed for 10 minutes or until dissolved. Next, the propylene glycol was added to the solution and mixed for another 10 minutes and then cooled to 70° C. while stirring.

The preservative Germaben II was added and mixed for five minutes. The fragrance was added and mixed for five minutes and the mixture was transferred to a pack out container and cooled to room temperature.

Air Freshener Formulations - Hot Process

| | Ingredients | Weight % |
|---|---|---|
| A | Carrageenan (Genugel RLV* from Hercules | 01.13% |
| | Incorporated) | 00.50% |
| B | HMHEC 1 (Hercules Incorporated) | 30.00% |
| C | Fragrance (Cinnamon) | 67.12% |
| D | Water | 00.25% |
| E | Surfactant (Dowfax 2A1**, Dow Chemicals, Midland, | 01.00% |
| | MI) | |
| F | Germaben II (Sutton Laboratory) | |
| | Total | 100.00% |

*Genugel RLV: Carrageenan standardized with sugar
**Dowfax 2A1: Benzene, 1,1-oxybis, tetrapropylene derivative, sulfonated sodium from Dow Chemical.

### Procedure

Water was heated to about 90° C. while being stirred and polymers A and B were added to the vortex of water and mixed for 10 minutes or until dissolved and then cooled to 80° C. while continued stirring. Next, the preservative Germaben II and surfactant were added and mixed for five minutes. The fragrance was added and mixed for five minutes and the hot mixture was injected into a porous foam substrate and cooled to room temperature and sealed into a nonpermeable wrap.

Air Freshener Formulations - Hot Process

| | Ingredients | Weight % |
|---|---|---|
| A | Agar | 01.00% |
| B | Starch | 00.25% |
| C | Natrosol-Plus 430* (Hercules Incorporated) | 00.25% |
| D | Water | 96.50% |
| E | Germaben II (Sutton Laboratory) | 01.00% |
| F | Fragrance (Cinnamon) | 01.00% |
| | Total | 100.00% |

*Natrosol-Plus 430 is nonionic hydrophobically modified hydroxyethylcellulose. It has long chain (C₁₆) alkyl group. Aqueous viscosity at 1.0% is between 5000-9000 cps Brookfield viscometer at spindle 3, 6 rpm.

### Procedure

Water was heated to about 90° C. while being stirred and polymers A, B, and C were added to the vortex of water and mixed for 10 minutes or until dissolved. Next, the solution was cooled to 70° C. while stirring. The preservative Germaben II was added and mixed for five minutes. The fragrance was added and mixed for five minutes and the mixture was transferred to a pack out container and cooled to room temperature.

Air Freshener Formulations - Cold Process

| Phase | Ingredients | Weight % |
|---|---|---|
| A | DASC (dihydroxyaluminum sodium carbonate) | 00.30% |
| B | CMC 7MT** (Hercules Incorporated) | 03.00% |
| C | HMHEC 2* | 00.25% |
| D | Potassium Sorbate | 00.12% |
| E | Propylene glycol | 05.00% |
| F | Water | 89.33% |
| G | Fumeric Acid | 01.00% |
| H | Fragrance*** | 01.00% |
| | Total | 100.00% |

*HMHEC 2 is 3-butoxy-2-hydroxypropylhydroxyethylcellulose that has aqueous viscosity at 25° C. of a minimum of 2000 cps at 1% measured on a Brookfield LVTD Viscometer and a cloud point of about 62°-68° C. without glyoxal treatment.
**CMC 7MT: Sodium carboxymethylcellulose with 0.65-0.90
***Fragrance: Wildflower from Flavor and Fragrance Specialties. degree of carboxymethyl substitution and 2% aqueous viscosity of 300-600 cps at 25□C.

### Procedure

DASC and potassium sorbate were added to the vortex of water in a container while stirring.

In a separate container, ingredients B, C, and G (CMC, HMHEC 2 and fumeric acid) were preblended and then the propylene glycol was slurried into the preblend.

The slurry was immediately added to the DASC dispersion and mixed for 15 minutes.

Next, the fragrance was added and mixed for five minutes or until well dispersed and the formulation was filled into a container and capped.

Air Freshener Formulations Cold Process

| Phase I | Ingredients | Weight % |
|---|---|---|
| A | CMC 7MF* (Hercules Inc.) | 03.10% |
| B | HMHEC 2 | 00.20% |
| C | Propylene glycol | 01.00% |
| D | Water | 95.70% |
| | Total | 100.00% |

*CMC 7MF: Sodium carboxymethyl cellulose with 0.65-0.90 degree of carboxymethyl substitution and 2% aqueous viscosity of 400-800 cps at 25□C.

### Procedure

Propylene glycol was added to the vortex of water in a vessel and mixed for 5 minutes.

Polymers A & B were added to the vortex of the water/propylene glycol mixture and mixed for 20 minutes or until dissolved.

| Phase II | Ingredients | Weight % |
|---|---|---|
| A | (AAB) (Aluminum Acetate Basic pure, Aldrich, Cat | 02.50% |
| | #28982-5) | |
| B | Water | 97.50% |
| | Total | 100.00% |

### Procedure

In a separate vessel A was added to water.

To 80 grams of Phase I, 20.0 grams of Phase II were added to the vortex of Phase I and mixed for 5 minutes. The product was poured into a container and allowed to be crosslinked.

The gel strength can be increased by increasing the concentration of Phase I and/or Phase II.

Insect Repellent Formulations

| | Ingredients | Weight % |
|---|---|---|
| A | Carrageenan (CHP1 from Hercules Incorporated) | 02.00% |
| B | CMC 7LT* (Hercules Incorporated) | 00.50% |
| C | HMHEC 2 (Hercules Incorporated) | 00.75% |
| D | Water | 92.75% |
| E | Propylene glycol (humectant, solubilizer) | 02.00% |
| F | Germaben II (Sutton Laboratory) | 01.00% |
| G | Insect Repellent (Flavor and Fragrance, | 01.00% |
| | Franklin Lakes, NJ) | |
| | Total | 100.00% |

*CMC 7LT: Sodium carboxymethyl cellulose with 0.65-0.90 degree of carboxymethyl substitution and 2% aqueous viscosity of 25-50 cps at 25$$ C.

### Procedure

Water was heated to about 90° C. in a container and polymers A, B & C were added to the vortex of water while stirring and mixed for 10 minutes or until dissolved. Propylene glycol was added next and mixed for 5 minutes. The mixture was cooled to 70° C. while mixing. Preservative Germaben II was added and mixed for five minutes. Insect repellant was then added and mixed for five minutes. This formulation was then transferred to a pack out container and cooled to room temperature.

Pet Shampoo

| | Ingredients | Weight % |
|---|---|---|
| A | Distilled water | 69.70% |
| B | Triethanol amine-lauryl sulfate (40% active) | 15.00% |
| C | Sodium lauroamphoteric (and) sodium trideceth sulfate | 10.00% |
| D | Cocoamide diethanol amine | 02.50% |
| E | Glycol stearate | 01.20% |
| F | Propylene glycol(and) diazolidinyl urea (and) | 00.75% |
| | Methyl paraben (and) propylparaben. (Preservative) | |
| G | HMHEC 1 | 00.60% |
| H | Fragrance (Wildflower) | 00.25% |
| I | Citric acid | pH adjust |
| | Total | 100.00% |

### Procedure

Polymer G was added to vortex of water in a vessel while being heated to 70° C. and stirred for five minutes. Next, TEAL and glycol stearate were added to the vessel in small quantities and mixed well between the additions. After all of the additions were made, the heat was turned off and the vessel was allowed to cool. When the vessel was cooled down to about 55° C., Cocamide DEA was added to the vessel. Next, the preservative was added. The pH in the vessel then was adjusted to about 5.0 with citric acid solution. The fragrance was added and mixed for five minutes. The formulation was then poured into a pack out container and the top of the container was fastened.

Pet Shampoo

| | Ingredients | Weight % |
|---|---|---|
| A | Distilled water | 69.45% |
| B | Triethanol amine-lauryl sulfate (40% active) | 15.00% |
| C | Sodium lauroamphoteric (and) sodium trideceth sulfate | 10.00% |
| D | Cocoamide diethanol amine | 02.50% |
| E | Glycol stearate | 01.20% |
| F | Propylene glycol(and) diazolidinyl urea (and) | 00.75% |
| | Methyl paraben (and) propylparaben (Preservative) | |
| G | HMHEC 1 | 00.60% |
| H | Pyrethrins (10%) | 00.50% |
| I | Citric acid | pH adjust |
| | Total | 100.00% |

### Procedure

Water was heated to 70° C. in a vessel while being stirred and the polymer was added to the vortex of the stirred water mixed for five minutes. Next, TEAL and glycol stearate were added in small quantities at a time to the vessel and mixed well between each addition. The heat was then turned off and the vessel was allowed to cool. After the vessel cooled to about 55° C., Cocamide DEA were added to the vessel. Next, the preservative was added. Then, the pH of the vessel was adjusted to about 5.0 with citric acid solution. Pyrethrin was added and mixed for an additional five minutes. The formulation was then poured into pack out containers.

Insect Repellent Lotion

| Phase | Ingredients | Weight % |
|---|---|---|
| A | HMHEC1 | 00.50% |
| | Distilled water | 78.25% |
| | Glycerin, USP | 02.00% |
| B | Glycol stearate | 02.75% |
| | Stearic acid | 02.50% |
| | Mineral oil | 02.00% |
| | Acetylated lanolin | 00.50% |
| | Cetyl alcohol | 00.25% |
| C | Distilled water | 09.00% |
| | Triethanolamine | 00.50% |
| D | Insect Repellent | 01.00% |
| | (Flavor and Fragrance, Franklin Lakes, NJ) | 00.50% |
| | Propylene glycol and diazolidinyl urea and | 00.75% |
| | Methylparaben and propylparaben | |
| | (Germaben II - Sutton Lab, Chatham, NJ) | |
| | Total | 100.00% |

### Procedure

HMHEC1 was dispersed in a vessel of well-agitated water (of Part A) by adding it to the vortex of the water. Next, glycerin was added to the vessel of water and polymer while mixing pH was adjusted to 8.5, and heated to 80° C. This slurry was mixed until dissolved. In a separate vessel, the Part B ingredients were blended together while heating to 80° C. This was mixed until dissolved. Part A was added to Part B with good agitation while the emulsion temperature of 80° C. was maintained. Next, Part C ingredients were combined in a separate vessel and added to the emulsion and mixed continuously while cooling to 40° C. Then, Part D ingredients including the insect repellant were added to the emulsion and mixed for five minutes. The preservative was added to the emulsion and mixed for 5 minutes or until mixed well. The formulation was then cooled to room temperature and filled into containers.

Institutional Liquid Soap

| Ingredients | Weight % |
|---|---|
| Water | 74.88% |
| Sodium C14-C16 olefin sulfonate, 40% active | 07.50% |
| Sodium lauroyl sarcosinate, 30% active | 06.66% |
| Cocamidopropyl betaine, 35% active | 06.66% |
| Glycol stearate | 01.00% |
| HMHEC 1 | 00.80% |
| Propylene glycol | 00.50% |
| Glycerin | 00.50% |
| Tetrasodium ethylene diamine tetracetate | 00.30% |
| Stearalkonium chloride | 00.10% |
| Chlorhexidine digluconate (20%) | 01.00% |
| Methylparaben | 00.10% |
| Total | 100.00% |

### Procedure

HMHEC 1 was dispersed in a container of stirred water and the pH was adjusted to about 8.0-8.5 while mixing to dissolve the polymer. The dissolution took about 45 minutes. The methylparaben was then added to the solution. While slowly stirring the water-soluble polymer solution, stearalkonium chloride, olefin sulfonate, and glycol stearate were added one at a time to the solution while stirring for five minutes between each addition. Next, the mixture was heated to 80° C. until all of the glycol stearate was dissolved and the solution turned opaque. Next, the remaining ingredients were added while cooling the solution slowly to room temperature. The color, cyclohexidine, and fragrance ingredients were added to complete the formulation. Then, the formulation was packaged.

All-Purpose Cleaner

| Ingredients | Weight % |
|---|---|
| HMHEC 3* | 00.30% |
| Rhodapex CD-128 (ammonium capryleth | 01.70% |
| sulfate - Rhone-Poulenc) | |
| Butyl Cellosolve | 03.50% |
| Sodium Metasilicate | 01.70% |
| Trisodium Phosphate | 01.00% |
| Water | 91.80% |
| | 100.00% |

*HMHEC 3 is 3-butoxy-2-hydroxypropylhydroxyethylcellulose that has aqueous viscosity at 25° C. of a minimum of 2000 cps at 1% measured on a Brookfield LVTD Viscometer and a cloud point of about 62°-68° C. with glyoxal treatment.

### Procedure

The polymer (HMHEC 3) was added to the vortex of stirred water in a vessel and the pH of the vessel was adjusted to 8.5 while mixing for 45 minutes or until fully dissolved. All of the other ingredients were then added to the vessel in the order they are listed above. Between the addition of each ingredient to the solution in the vessel, the solution was stirred for five minutes.

For aerosol use, 85% of the solution was mixed with 15% propellant Genetron 12, from Allied Corporation.

Disinfectant

| | Ingredients | Weight % |
|---|---|---|
| A | Water | 90.75% |
| B | HMHEC 3 | 00.75% |
| C | Benzalkonium | 05.00% |
| | (Barquat 80-28 from | |
| | Lonza Inc. Fair Lawn NJ) | |
| D | Nonionic surfactant | 01.00% |
| E | Isopropanol | 02.00% |
| F | Lemon Oil | 00.50% |
| | Total | 100.00% |

### Procedure

The polymer (HMHEC 3) was added to the vortex of stirred water in a vessel and the pH of the vessel was adjusted to 8.5 while mixing for 45 minutes or until dissolved. All of the other ingredients were then added to the vessel in the order they are listed above. Between the addition of each ingredient to the solution in the vessel, the solution was stirred for about five minutes or until the ingredient was well mixed into the solution. The formulation was then poured into a pack out container.

Soap Bar

| | Ingredients | Weight % |
|---|---|---|
| Phase I | | |
| A | Sodium cocoylisethionate | 70.00% |
| | (64% active, Geropon AS200 | |
| | from Rhone Poulenc) | |
| B | Stearic acid, triple pressed | 15.30% |
| C | Hectorite | 05.00% |
| D | HMHEC 3 | 01.00% |
| Phase II | | |
| A | Water | 07.49% |
| B | Sodium chloride | 00.50% |
| C | Dye (FD&C Red No. 40) | 00.01% |
| D | Titanium dioxide | 00.20% |
| Phase III | | |
| A | Fragrance | 00.50% |
| | Total | 100.00% |

### Procedure

First, all the ingredients in Phase I were dry blended uniformly using a kitchen mixer. In a separate container, the Phase II ingredients, NaCl, titanium dioxide and dye, were mixed with water and then added to the Phase I ingredients in the kitchen mixer and continued to be mixed. Phase III ingredient was then added to the mixer containing the Phase I & II ingredients while mixing and the mixing was continued until the ingredients in the mixer were homogeneous. This formulation was then extruded through an extruder and packaged.

Rug and Upholstery Shampoo

| Ingredients | Weight % |
|---|---|
| HMHEC 1 | 00.50% |
| Rhodapex ES (sodium laureth sulfate - | 20.00% |
| Rhone-Poulenc) | |
| Sodium tripolyphosphate | 02.00% |
| Ethyl carbitol | 01.50% |
| Tinopal 5BM (Triazinyl stilbene - Ciba- | 00.05% |
| Geigy Corp.) | |
| Water | 75.95% |
| Total | 100.00% |

### Procedure

The polymer HMHEC 1 was added to the vortex of stirred water in a vessel and the pH of the mixture in the vessel was adjusted to about 8.5 and stirred for about 45 minutes or until dissolved. The other ingredients were added one at a time in the order listed above. Each ingredient was mixed into the solution for 5 minutes at slow speed. After all of the additions, the formulation was poured into a container.

Liquid Laundry Softener-Detergent

| Ingredients | Weight % |
|---|---|
| Water deionized | 46.70% |
| HMHEC 3 | 00.50% |
| Varisoft 3690 (Imidazolium compound - | 07.00% |
| Witco) | |
| Varonic T210 (PEG-10 hydrogenated | 25.00% |
| tallow amine - Witco) | |
| Ethyl alcohol | 05.00% |
| Citric Acid (15%) | 15.80% |
| Total | 100.00% |

### Procedure

The polymer HMHEC 3 was added to the vortex of stirred water in a vessel, the pH was adjusted to about 8.5, and was heated to about 60° C. and mixed for about 30 minutes or until the polymer was dissolved. Varonic ingredient was added to the vessel and mixed until fully dissolved. Next, the Varisoft ingredient was added slowly while mixing. Heat was then turned off and mixing was continued in the vessel until the solution in the vessel was cooled. The remaining ingredients were added to the vessel and mixed. During the mixing cycle the rate of agitation was adjusted to minimize foaming. The formulation was then poured into a container.

Bacteriostatic Laundry Softener

| Ingredients | Weight % |
|---|---|
| Water | 06.20% |
| HMHEC 3 | 00.50% |
| Bardac 2050 (Polyquaternium-24 - | 60.00% |
| Lonza Inc., Fair Lawn, NJ) | |
| Carsosoft CFI-90* (Lonza Inc.) | 33.30% |
| Total | 100.00% |

*Carsosoft CFI-90: 1-Oleylamidoethyl-1-methyl-2-heptadecenylimidazolininon methosulfate

### Procedure

Carsosoft and Baradac ingredients were mixed together in a vessel. Next, water was added to the vessel and mixed. This was followed by the addition of HMHEC 3 while mixing.

The pH of the mixture in the vessel was adjusted to 8.5 and mixed until all ingredients were dissolved. This formulation was then packed out in a container.

Automatic Dishwashing Detergent

| Ingredients | Weight % |
|---|---|
| Sodium tripolyphosphate | 39.50% |
| HMHEC 2 | 01.50% |
| Makin NF-5 (Alkoxylated | 03.00% |
| isopropanolamide - Stepan) | |
| Britesil H-20 (Sodium polysilicate - | 30.00% |
| PQ Corporation) | |
| CDB Clearon (Sodium | 02.00% |
| dichloroisocyanurate, Olin Corporation) | |
| Sodium Carbonate, dense | 24.00% |
| Total | 100.00% |

### Procedure

Blender was charged with the carbonate ingredient. This was followed by the addition of the Makin ingredient and then the remaining ingredients. The blender was run for five minutes between each addition. The mixing was continued for 30 minutes or until homogeneously mixed. Once all the ingredients were added, the product was filled in a container.

Liquid Handsoap

| Ingredients | Weight % |
|---|---|
| Calblend clear (Sodium laureth sulfate (and) | 30.00% |
| cocamide DEA (and) cocamidopropyl betaine - | |
| Pilot Chemicals, Santa Fe Springs, CA) | |
| HMHEC 1 | 00.50% |
| Fragrance (strawberry) | 00.25% |
| Dye | 00.05% |
| Water | 69.20% |
| Total | 100.00% |

### Procedure

HMHEC1 was added to the vortex of stirred water in a blender and was mixed until a slurry was formed. The pH of the slurry was adjusted to 8.5 and mixed for 45 minutes or until fully dissolved. Calblend clear ingredient was added next. This was followed by the addition of the fragrance and dye. The solution was mixed for 5 minutes between each addition and for 30 minutes after all of the ingredients were added.

Toilet Bar Soap

| | Ingredients | Weight % |
|---|---|---|
| Phase I | | |
| A | Croamol CAP | 10.00% |
| | (Ceteary octanoate, Croda Inc., | |
| | Parsippany, NJ) | |
| B | Promyristyl PM3 | 50.00% |
| | (PPG3 myristyl ether, Croda) | |
| C | Procetyl AWS | 08.00% |
| | (PPG5-ceteth20, Croda) | |
| Phase II | | |
| A | Sodium stearate | 08.00% |
| B | HMHEC 2 | 02.00% |
| Phase III | | |
| A | Deionized water | 10.00% |
| B | Propylene glycol | 06.00% |
| C | Glycerin | 06.00% |
| | Total | 100.00% |

### Procedure

First, ingredients in Phase I were blended together in a mixer. Next, they were heated to 80° C. while continued mixing. Then, ingredients in phase 11 were added to the mixer and the temperature was maintained during the mixing. Once the ingredients in the mixer appeared to be homogeneous, ingredients of Phase III were added one at a time. The mixer was run on medium speed between each addition until the slurry appeared homogeneous. Next, the slurry was cooled to 65° C. while mixing and then poured into a mold and packaged.

Toilet Bowl Cleaner

| Ingredients | Weight % |
|---|---|
| Simulsol SL 10* (Seppic Co. Fairfield, | 05.50% |
| NJ) | |
| Solagum SH210** (Seppic Co.) | 01.50% |
| HMHEC 2 | 01.00% |
| Citric Acid | 03.00% |
| Water | 89.00% |
| Total | 100.00% |

*Simulsol SL10: Nonionic surfactant, glucose alkylpolyglucose
**Solagum SH210: Aqueous solution of synthetic copolymer dispersed in isoparaffin

### Procedure

Solagum and HMHEC 2 ingredients were added to the vortex of stirred water in a blender and then mixed for 45 minutes. This was followed by the addition of Simulsol and citric acid ingredients while mixing and then mixed for an additional 15 minutes and then packaged.

Toilet bowl Tablets, Rim Block, In-Cistrern Block

| Ingredients | Weight % |
|---|---|
| Sodium sulfonate | 49.99% |
| Ethoxylated fatty acid tallow | 10.00% |
| Tallow fatty acid monoethanolamide | 03.00% |
| HMHEC 1 | 09.00% |
| Magnesium carbonate | 04.00% |
| Sodium sulfate | 20.00% |
| Fragrance | 04.00% |
| Dye (FD&C blue 2 alum lake) | 00.01% |
| Total | 100.00% |

### Procedure

All of the ingredients, except the fragrance, were blended in a blender until homogeneous. The ingredients were added in the order listed above. The fragrance was sprayed into the blender while blending at medium speeds until homogeneous. The formulation was then extruded through a die at about 100C and cooled to room temperature, cut, and packaged. The formulation could also contain other salts, such as sodium silicate, silicas, sodium carbonate, sodium citrate, etc. if needed to obtain desired pH, density, solubility etc.

Liquid Laundry Detergent

| Ingredients | Weight % |
|---|---|
| Water | 59.75% |
| HMHEC 3 | 00.25% |
| Triethanol amine | 02.00% |
| Witco 1298* (Witco Dublin, OH) | 05.00% |
| propylene glycol | 05.00% |
| Witconol 25-7** (Witco) | 15.00% |
| Varonic K205*** (Witco) | 13.00% |
| Total | 100.00% |

*Witco 1298: Dodecylbenzene sulfonic acid linear
**Witconol 25-7: Alcohol ethoxylate
***Varonic K205: PEG-5 cocamine

### Procedure

HMHEC 3 was added to the vortex of stirred water in a blender, pH was adjusted to about 8.5, and mixed until dissolved. Next, triethanolamine was added to the blender and mixed for 30 minutes. The rest of the ingredients were added one at a time, in the order they are listed above, while mixing. Between each addition, the solution was mixed until the ingredients were dissolved. After all of the additions were made, the solution was mixed for an additional 30 minutes. The speed of agitation was adjusted as necessary to minimize foaming. The solution was packaged.

Laundry Prespotter

| Ingredients | Weight % |
|---|---|
| Water | 77.10% |
| HMHEC 2 | 00.25% |
| Witconol 25-7 (Witco) | 07.00% |
| Varonic K205 (Witco) | 04.00% |
| Witconate 45* liquid (Witco) | 10.00% |
| D'limonene | 01.00% |
| Methyl paraben | 00.15% |
| Fragrance | 00.50% |
| Total | 100.00% |

*Witconate 45: Sodium dodecylbenzene sulfonate and sodium xylene sulfonate

### Procedure

The ingredients were added in the order listed above with constant agitation in a mixer.

Mixing was continued until the mixture of the ingredients was lump free and homogeneous.

Liquid Abrasive Cleaner

| Ingredients | Weight % |
|---|---|
| Water | 46.00% |
| Calcium carbonate | 50.00% |
| Acusol 820 (30% Acrylic polymer, Rohm | 01.00% |
| and Haas Company) | |
| HMHEC 1 | 00.50% |
| Bentonite clay (8.0% dispersion) | 02.50% |
| Total | 100.00% |

### Procedure

The ingredients were added to the water in a mixer in the order that they are listed above.

Next, pH was raised to 8.5 and the slurry was then mixed for 30 minutes or until lump free to form the final formulation.

Fabric Sizing Spray

| | Ingredients | Weight % |
|---|---|---|
| Phase I | | |
| A | Deionized Water | 68.35% |
| B | HMHEC 3 | 00.50% |
| C | Carboxymethyl cellulose (CMC7L1T*, | 01.00% |
| | Hercules Incorporated | |
| Phase II | | |
| A | Sodium lauryl sulfate | 00.05% |
| | (Witcolate A, Witco) | |
| B | Methylparaben | 00.10% |
| C | Deionized Water | 30.00% |
| | Total | 100.00% |

*CMC 7L1T: Sodium carboxymethylcellulose, with carboxymethyl substitution of 0.65-0.90 and 4% aqueous viscosity of 25-50 cps at 25□C.

### Procedure

In Phase I, the polymers HMHEC 3 and CMC were added to the vortex of stirred water in a blender, the pH of the slurry in the blender was adjusted to 8.5, and the slurry was mixed until the polymers were fully dissolved. The surfactant and preservative were added to a separate mixer containing the water of Phase II and mixed until these components were fully dissolved. Phase II solution was then added to the vortex of Phase I solution and mixed for 10 minutes or until lump free. This formulation was then packed out in a container. For aerosol spray, the system was charged with a propellent.

What is claimed:

1. A household product composition comprising:
(a) from about 0.1% to about 99% by weight of a vehicle system which comprises a hydrophobically modified water soluble polysaccharide polymer which comprises a water soluble polysaccharide polymer backbone selected from the group consisting of hydroxyethylcellulose (HEC), hydroxyoropylcellulose (HPC), methylcellulose (MC), hydroxypropylmethylcellulose (HPMC), ethyl hydroxyethylcellulose (EHEC), and methyl hydroxyethylcellulose (MHEC), agar, dextran, locust bean gum, starch, guar, and their nonionic derivatives, and mixtures thereof and a hydrophobic moiety selected from the group consisting of 3-alkoxy-2-hydroxypropyl group wherein the alkyl moiety is a straight or branch chain having 3-24 carbon atoms wherein the hydrophobic moiety is attached tot he backbone by an ether linkage and is present in an amount up to the amount which renders said polysaccharide less than 1% by weight soluble in water and
(b) at least one active household care ingredient selected from the group consisting of cleaning, sanitizing, polishing, pesticide, fabric softeners, and toilet preparation products, and mixtures thereof.

2. The composition of claim 1 wherein the composition also comprises from about 0.01% to about 50% by weight of the household composition of a surfactant.

3. The composition of claim 2 wherein the surfactant is selected from the group consisting of anionic, nonionic, cationic, zwitterionic, and amphoteric, mixtures thereof.

4. The composition of claim 1 wherein the composition also comprises from about 0.1% to about 99% by weight of the household composition of a compatible solvent or solvent mixture.

5. The composition of claim 4 wherein the solvent or solvent mixture is selected from the group consisting of water, water-lower alkanols mixtures, polyhydric alcohols and mixtures thereof.

6. The composition of claim 5 wherein the solvent or solvent mixture is selected from the group consisting of water, propylene glycol, water-glycerine, sorbitol-water, water-ethanol, and mixtures thereof.

7. The composition of claim 2 wherein the composition also comprises from about 0.1% to about 99% by weight of the household composition of a compatible solvent or solvent mixture.

8. The composition of claim 1 wherein the hydrophobically modified polysaccharide backbone is selected from the group consisting of hydroxyethylcellulose (HEC), hydroxypropylcellulose (HPC), methylcellulose (MC), hydroxypropylmethylcellulose (HPMC), ethylhydroxyethylcellulose (EHEC), and methylhydroxyethylcellulose (MHEC), and agar, dextran, locust bean gum, starch, guar, and their nonionic derivatives, and mixtures thereof.

9. The composition of claim 1 wherein the polysaccharide backbone is HEC.

10. The composition of claim 1 wherein the hydrophobic moiety is 3-butoxy-2-hydroxypropyl.

11. The composition of claim 1 wherein the hydrophobic moiety is cetyl.

12. The composition of claim 1 wherein the polysaccharide backbone is HPC.

13. The composition of claim 1 wherein the hydrophobic moiety is an alkyl radical having 4-16 carbons.

14. The composition of claim 4 wherein the composition also contains an effective viscosifying amount of a salt.

15. An air freshener/deodorizer composition comprising a solvent and an effective amount of the household composition of claim 4.

16. An insect repellent comprising an effective amount of the household composition of claim 4.

17. A bubble generating liquid comprising an effective amount of the household composition of claim 7.

18. A pet shampoo and shampoo-conditioner comprising an effective amount of the composition of claim 1.

19. A liquid soap product comprising industrial grade soap actives and an effective amount of the household composition of claim 7.

20. All purpose cleaner comprising an effective amount of household composition of claim 1.

21. A disinfectant comprising an effective amount of the household composition of claim 1.

22. A anti-itching lotion composition comprising an effective amount of the household composition of claim 4.

23. A bar soap composition comprising industrial grade soap actives and an effective amount of the household composition of claim 7.

24. A rug and upholstery cleaning composition comprising an effective amount of the household composition of claim 7.

25. A rug and upholstery cleaning composition comprising an effective amount of the household composition of claim 1.

26. A rug bleaching agent composition comprising an effective amount of the household composition of claim 1.

27. A laundry softener composition comprising an effective amount of the household composition of claim 7.

28. A dishwashing detergent composition comprising an effective amount of the household composition of claim 7.

29. A toilet bowl cleaner composition comprising an effective amount of the household composition of claim 7.

30. A laundry prespotter composition comprising an effective amount of the household composition of claim 1.

31. An auto cleaning composition comprising an effective amount of the household composition of claim 7.

32. The composition of claim 1 where the household composition also comprises an oil-in-water or water in oil emulsion.

33. A pet dental cleaning and deodorizing composition comprising an effective amount of the household composition of claim 1.

34. A laundry detergent composition comprising an effective amount of the household composition of claim 7.
